(19) United States
(12) Patent Application Publication
(10) Pub. No.: US 2013/0028094 A1
(43) Pub. Date: Jan. 31, 2013

(54) FIBER CHANEL DEVICE

(71) Applicant: Zhonghua Gao, Beijing (CN)

(72) Inventor: Zhonghua Gao, Beijing (CN)

(21) Appl. No.: 13/556,953

(22) Filed: Jul. 24, 2012

(30) Foreign Application Priority Data
Jul. 25, 2011 (CN) 201110209156.7

(51) Int. Cl. H04L 12/24; H04L 12/56

(52) U.S. Cl. 370/238; 370/400

(57) ABSTRACT

A fiber channel device comprising a processor to distribute and receive link constraint information on available links when there is a need to transmit data packets to a destination, and to establish a constraint-based routed label switch path (CRLSP) to transmit data packets to the destination.

### CLAIM FOR PRIORITY

The present application claims priority under 35 U.S.C. 119 (a)-(d) to Chinese Patent application number 201110209156.7, filed on Jul. 25, 2011, which is incorporated by reference herein in its entirety.

### BACKGROUND

Fiber Channel (‘FC’) is a set of standards that define a high performance data transport connection technology for transmission of many kinds of data at speeds up to four gigabit per second currently through copper wire or fiber optic cables.

Fiber Channel distinguishes itself in its ability to handle high-speed data transfer, varieties of data types and cable media, and long distances. As such, Fiber Channel has been widely used to connect workstations, main frames, supercomputers, storage area networks (SAN) in enterprise storage and displays.

### DESCRIPTION OF FIGURES

Fiber Channel devices and network will be described below by way example with reference to the accompanying drawings, in which:

FIG. 1 is an example network of Fiber Channel devices in interconnection,

FIG. 2 is a schematic function block diagram of a processor of an example Fiber Channel device,

FIG. 3 is a schematic diagram showing an example LSU (Link State Update) packet,

FIG. 4 is a schematic diagram showing an example LSR (Link State Record) Packet,

FIG. 5 is a schematic diagram showing an example TLV packet;

FIG. 6 is a schematic diagram showing an example FC network with a CRLSP set up;

FIGS. 7A to 7D are schematic diagrams depicting a flow of PATH message from FC2 to FC3;

FIGS. 8A to 8E are schematic diagrams depicting a flow of PATH message from FC3 to FC5;

FIGS. 9A to 9C are schematic diagrams depicting a flow of RESV message feedback by FC8 to FC7;

FIGS. 10A to 10C are schematic diagrams depicting a flow of RESV message feedback by FC7 to FC6; and

FIG. 11 is a function block diagram of an example FC device.

### DESCRIPTION

The fundamental entity in Fiber Channel is the Fiber Channel network which is largely specified by functional elements and the interfaces between them. These consist, in part, of the following:
N_PORT is a port on a node which can be a host or storage device.
E-PORT is the connection between two Fiber Channel switches. When E_PORTS between two switches form a link, that link is referred to as an inter-switch link (ISL).
FC Devices—The fiber channel devices to which the N_PORTs provide access.
Fabric Ports—The interfaces within a fiber channel network that provide attachment for an N_PORT.

Fabric Shortest Path First (FSPF) is the standard path selection protocol used by Fiber Channel fabrics. FSPF is enabled by default on all Fiber Channel switches, and FSPF automatically calculates the best path between any two switches in a fabric. Specifically, FSPF is used to:
Dynamically compute routes throughout a fabric by establishing the shortest and quickest path between any two switches.
Select an alternative path in the event of the failure of a given path. FSPF supports multiple paths and automatically computes an alternative path around a failed link. It provides a preferred route when two equal paths are available.

FSPF is a Link State path selection protocol, similar to OSPF, which is an Interior Gateway Protocol (IGP). This protocol keeps track of the state of the links on all switches in the Fabric. It also associates a cost with each link. The protocol computes paths from a switch to all the other switches in the fabric, by adding the cost of all the links traversed by the path, and choosing the path that minimizes the cost. In order for the protocol to work, the cost must be a positive integer number. The collection of link states (including cost) of all the switches in a fabric constitutes the topology database.
FSPF has the following major components:
A Hello protocol, used to establish connectivity with a neighbor switch, to establish the identity of the neighbor switch, and to exchange FSPF parameters and capabilities.
A replicated topology database, with the protocols and mechanisms to keep the databases synchronized across the fabric.
A path computation algorithm.
A routing table update.

However, routes selected by using FSPF are not satisfactory in many circumstances, for example, when the FSPF selected path is congested.

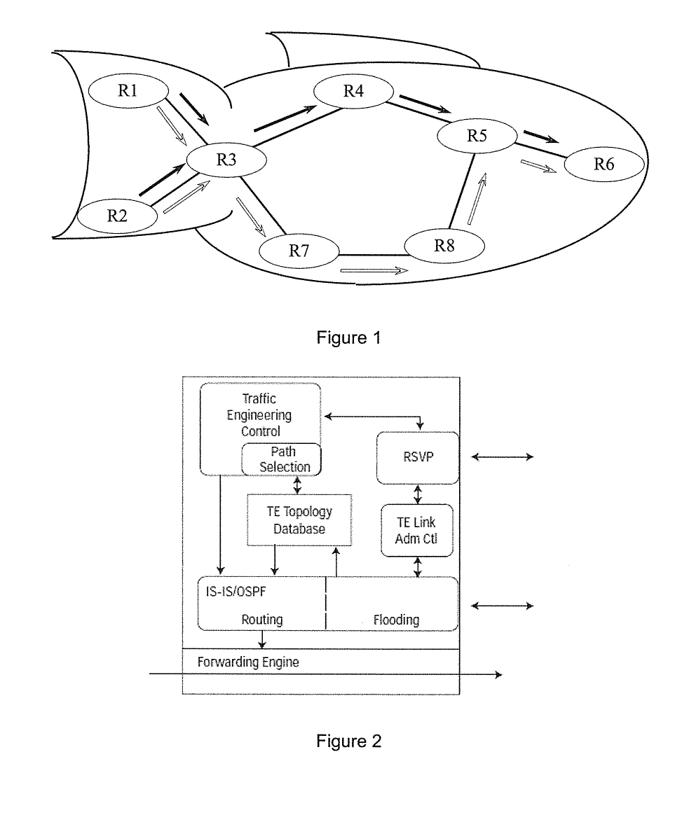

An example Fiber Channel network of FIG. 1 comprises a plurality of Fiber Chanel devices R1-R8 connected by a plurality of Fiber Channel links. The Fiber Channel network can be a SAN (Stored Area Network) or other networks. Fiber Channel devices R1, R2 and R6 are end node devices while Fiber Channel devices R3-R5 & R7-R8 are intermediate node devices. An end node device can be, for example, a server, a host, a disk array, a workstation, a tape library, or the like. An intermediate node device can be, for example, a hub, a switch or a router. A link can be a fiber optic link or a copper link.

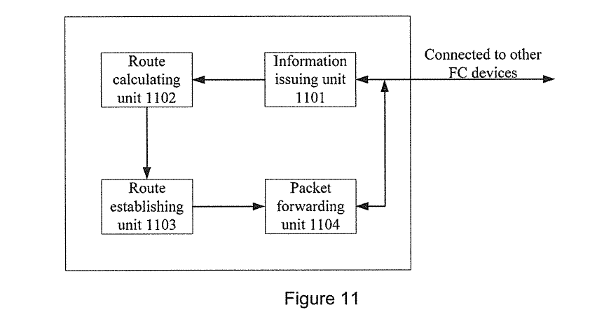

The Fiber Channel device (FC device) of FIG. 11 comprises a processor, a storage device and data communication interfaces such as input and output ports. The FC device processor is adapted to operate the FC device in the FSPF (Fiber Shortest Path First) protocol environment so that data traffic is forwarded from a source (or head-end) FC device to a destination (or tail-end) FC device through label switched paths (LSP) across a plurality of intermediate FC devices in a FC network.

To enable traffic management so that there is an alternative path to the shortest path as the only optimal path for data traffic in a FC network, the FC device is configured to be capable of implementing traffic engineering policy management by taking into account constraint such as bandwidth availability or traffic characteristics. In the example FC network herein, the processor of the FC device is set to implement MPLS traffic engineering (MPLS TE) and to used constraint-based routing algorithms to set an optimal path which are formed on Label Switched Paths (LSP). The LSPs which connect the head-end FC device to the tail-end FC device are collectively referred to as CRLSP (constraint based routing LSP), since the LSPs are based on constraint based routing (CSR), and constraint based algorithm is used to find the best optimal path to define an LSP tunnel.

In general, the head-end FC device will determine the best path when (1) a new tunnel is requested, (2) the current LSP of an existing trunk has failed, and (3) to re-optimize an existing trunk. Each intermediate Fiber Channel device in the FC network is configured as a Label Switched Router (LSR) to facilitate traffic in MPLS environment.

In general, the Fiber Channel device is adapted to perform the following traffic engineering (TE) functions to perform MPLS TE functions:
Information distribution—sends information about network topology and constraints pertaining to links (i.e., bandwidth).
Path selection algorithm—computes and selects best paths that obey the constraints.
Route setup—Resource Reservation Protocol TE (RSVP-TE) extension for signaling LSPs setup.
Link Admission Control: decides which tunnel may have resources.
TE control: establishes and maintains trunks.
Forwarding data across the path.

Traffic Engineering (TE) in the present context refers to the process of selecting paths chosen with reference to data traffic constraints such as available bandwidths in order to facilitate efficient and reliable network operations while simultaneously optimizing network resource utilization and traffic performance. TE is usually applied to compute and select a path from one given node to another which does not violate any constraints, such as bandwidth and/or administrative requirements and is optimal with respect to some scalar metric. Once a preferred path is computed and selected, TE is responsible for establishing and maintaining forwarding state along such a path to facilitate data communication with other Fiber Channel devices.

Existing protocols such as Interior Gateway Protocols (IGP) are not adequate to implement traffic engineering on Fiber Channel network, and routing decisions are mostly based on shortest path algorithms that generally use additive metric and do not take into account bandwidth. FSPF protocol is modified by introduction new Link State Records (LSR) containing link information for TE (TE Link Information) into a LSU message to facilitate implementation of traffic engineering in FC network environment.

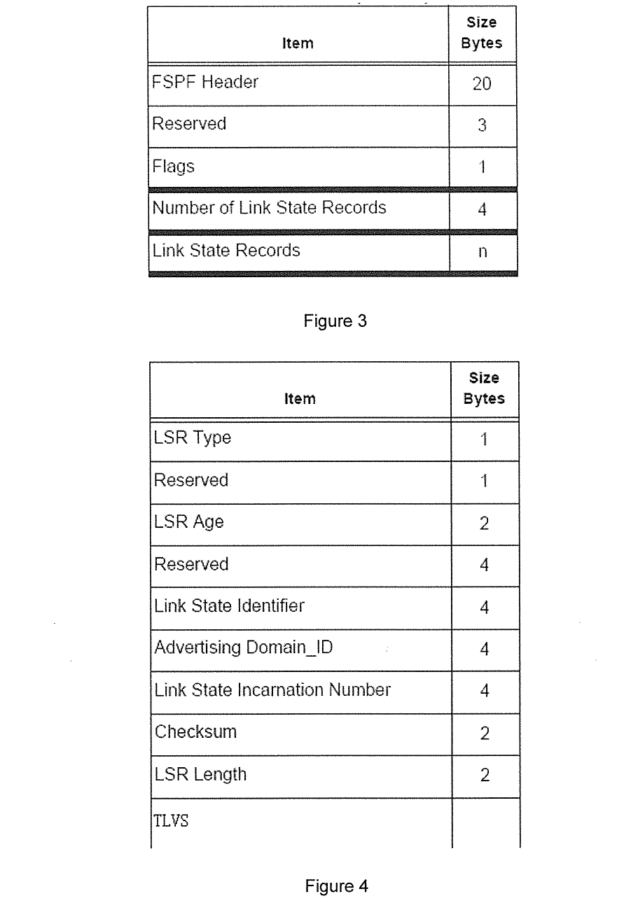

When establishing the CRLSP tunnel, the following constraints will usually be considered:
1. Whether Strict Explicit Route and Loose Explicit Route is supported.
2. Whether the remaining or available bandwidth meets the CRLSP tunnel requirements?
3. Whether the affinity attributes satisfy the CRLSP tunnel requirements?
4. Whether the TE Metric is the minimum?
As shown in FIG. 3, a FSPF header comprises the following fields:
Version: The current version of FSPF, which is 2.
Section ID: Identifies a Section which identifies a set of switches that share an identical topology database. This item has been rendered obsolete in FC-SW-4.
Authentication Type: The type of authentication to be used in the ‘Authentication’ field. It should be set to 0 for no authentication.
Originating Domain ID: The ID of the switch that transmitted the message.
Authentication: The Authentication string. It should be 0 if Authentication Type is 0.
   The command field is defined below:

| Encoded Value (hex) | Description | Abbr. |
|---|---|---|
| 14000000 | Hello | HLO |
| 15000000 | Link State Update | LSU |
| 16000000 | Link State Acknowledgement | LSA |
| . . . | . . . | . . . |

The LSU packet to be added to provide the TE link information may have the following format:

| Encoded Value (hex) | Description | Abbr. |
|---|---|---|
| Value to be assigned | TE Link State Update | TE_LSU |

A FSPF header with the above modifications is shown in FIG. 3 and the newly added TE link information LSR (Link State Records) will have the definitions depicted in FIG. 4.

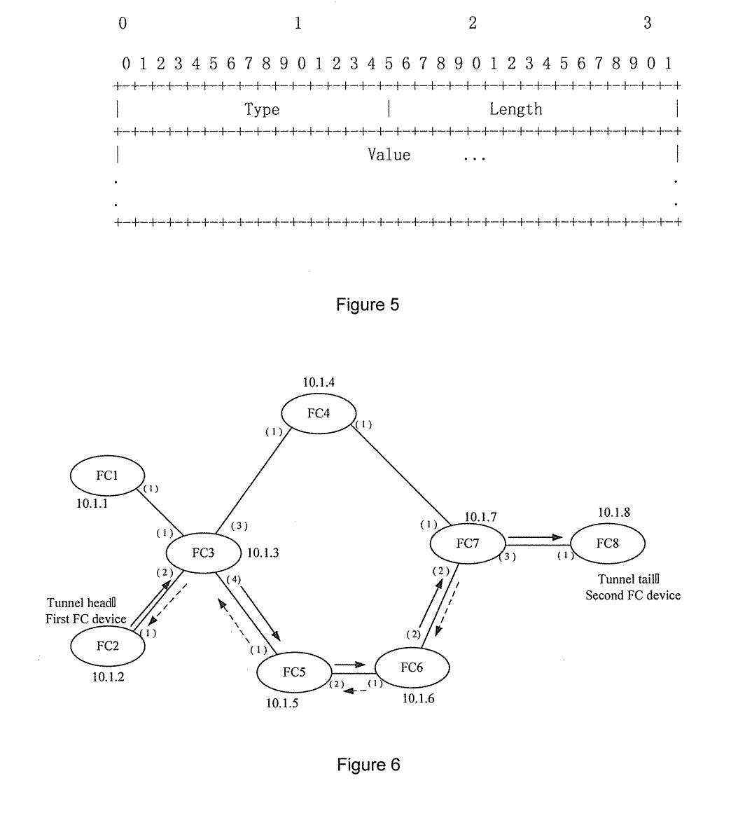

When comparing with the Link State Record (LSR) of the current FSPF protocol, the modified LSR no longer carries a Link Descriptor, and TE Link Information on a link associated with the FC device is directly appended to the LSR as TLV packets. A TLV (type, length, value) packet having a format as depicted in FIG. 5 comprises information on type (T), length (L) and value (V).

In an example, the following eight types of TLV fields are used:

| Type | Length |
|---|---|
| 1 | Link type (1 octet) topology information, indicating |
| | whether the link type is P2P or MultiCast |
| 2 | Link ID (4 octets) topology information, indicating |
| | Domain_ID of the link's neighbor |
| 3 | Local/Remote Index(8 octets) topology |
| | information, indicating E_port Index local to the |
| | link and the neighbor E_prot Index |
| 4 | Traffic engineering metric (4 octets), metric |
| | information of link TE |
| 5 | Maximum bandwidth (4 octets), maximum |
| | bandwidth information of the link TE |
| 6 | Maximum reservable bandwidth (4 octets), |
| | maximum reservable bandwidth information of the |
| | link TE |
| 7 | Unreserved bandwidth (32 octets), remaining |
| | bandwidth information of the link TE |
| 8 | Administrative group (4 octets), affinity attribute |
| | information of the link TE |

Furthermore, the Local/Remote Index also differs from the of the original OSPF (open Shortest Path First) TE Link Information and has the following data format:

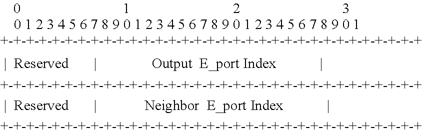

Apart from the above modifications, no other types of packets of the FSPF protocol require modification or adaptation to implement TE on a Fiber Channel network. With the implementation of the above modified FSPF protocol, the Fiber Channel device is now equipped with TE link resources management capability and can manage traffic resources on associated links to select an optimal path according to link resources available on the paths.

In general, a FC device having TE link resource management capability will have the following TE characteristics or ability, whether in combination or individually:
to configure the maximum reservable bandwidth on the link and allows allocation of a proportion of bandwidth resources when a prescribed quota is exceeded;
to support bandwidth reservation models such as RDM (Russian Dolls Bandwidth Constraint Model) and MAM (Maximum Allocation Model), and to configure the reservable bandwidth for each CT (class type) on the link at different bandwidth reservation modes;
to support configuration of TE metrics;
to distribute or release bandwidth resources on a link when a TE CRLSP (Constraint-based Routed Label Switched Path) is established or demolished. For example, to determine based on the bandwidth reservation model the setup priority of a CRLSP and the traffic type (CT) of the CRLSP whether there is sufficient bandwidth for distribution and whether it needs to take over bandwidth occupied by a CRLSP of a lower priority;
to configure TE affinity attribute of the link;
to disseminate TE information according to the FSPF protocol.

In addition, a FC device will have the following specific characteristics or requirements:
to support TE link resource management function on its E-ports;
to support TE link resource management function based on VSAN (Virtual SAN) topology, since a single E_Port can be connected to different VSAN on which different FSPF are run. However, each PSPF instance will only issue the TE link resources information of the VSAN corresponding to the E_Port.

The above can be represented by the following representations:

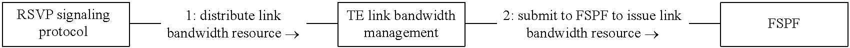

In process 1 above, the RSVP signaling protocol is used to distribute link resources when establishing the CRLSP according to the bandwidth required by the CRLSP and the affinity attribute. In process 2 above, there is a change in the link resources on a VSAN and it becomes necessary to inform such changes by the FSPF protocol.

The distribution or flooding of TE link information on a FC network is different to the flooding of TE information using OSPF in an IP network in that:

1. Running of OSPF is based on an interface, that is to say, the TE link information of the interface is flooded. On the other hand, the running of FSPF is based on a VSAN on an interface, that is to say, the TE link information of the VSAN corresponding to the FSPF instance on the interface is flooded.
2. The topology information for the flooding of TE link information using OSPF is based on the IP address of the interface or can be based on the IP UnNumber. On the other hand, flooding of TE link information by the FSPF is only similar to that of IP UnNumber because a FC network does not have an interface addresses.

A Fiber Channel device (‘FC device’) adapted to process the modified FSPF protocol to facilitate traffic engineering (TE) management in the MPLS FC network environment will rely on the Integrated Gateway Protocol (IGP) or FSPF to flood or distribute link-related information on resources availability. In operation, a Fiber Channel device incorporating the modified FSPF protocol will established tunnels and flood the Fiber Channel Network with TE Link Information using the modified FSPF protocol according to the established flood procedures of the FSPF protocol to establish a traffic engineering database (TEDB), to compute and select an optimal path, and to establish and maintain the selected path for data communication.

The link-related information on resources availability include, for example, bandwidth available for reservation or reservable bandwidth, link attributes, TE specific link metrics, resource class attributes for a link. The information on available bandwidth includes available bandwidth per priority, and there are seven levels of priority level which are identified by level 0 to level 7. The available bandwidth information per priority further includes information on maximum link bandwidth, maximum reservation bandwidth, and reserved bandwidth. Link related resource information is disseminated on the FC network and received by individual FC devices through the E_Ports (which are input- and output ports) according to the established FSPF protocol while using the modified FSPF protocols with the added LSU messages. The FC device will then determine and select an optimal path according to link resource availability information thus acquired.

Example operation of a FC device in a MPLS FC network environment will be explained with reference to a FC network of FIG. 6 which comprises eight FC devices, in which FC1, FC2 and FC8 are end node FC devices while FC3-FC7 are intermediate node FC devices. The address and port or interface index number of each FC devices are shown on the Figure for easy reference. Assuming that a first end node FC device FC2 is required to send data messages to a second end node device FC8, each FC device in the FC network will flood its TE link information onto the FC network for reception by all other FC devices on the FC network. The TE link information will include, for example, information on bandwidth available or remaining on the TE link, the TE Metric of the TE link, maximum reservable bandwidth of the TE link, and the affinity attribute of the TE link. The TE link information of each FC device is carried by a TE_LSU packet, the TE_LSU packets are transferred to neighboring FC devices on a layer by layer basis such that each FC device can obtain the TE link information of all other FC devices in the FC network.

When it is necessary for FC2 to transmit data packets to FC8, the first end node FC device FC2 (as the head-end node FC device) will determine a data forwarding path for forwarding the data packets to the second end node FC device FC8 (as the tail-end node FC device). This packet forwarding path will be determined using MPLS TE principles and by taking into account traffic constraint factors such as bandwidth availability and traffic characteristics of the available links. The traffic constraint information is collected by FC2 by initiating the flooding process on the FC network such that the TE link information of FC2 and the TE link information of all other FC devices connected to the FC network will be collected by FC2.

Upon collection of all the necessary traffic constraint information by FC2, FC2 will implement traffic engineering policies to determine and select preferred paths based on data traffic constraints to optimize network resource utilization. The preferred path can be determined by, for example, using the CSPF (Constrained Shortest Path First) algorithm. For example, FC2 of FIG. 6, or more specifically the processor of FC2, will set up a CRLSP tunnel which passes through the intermediate node devices FC3, FC5, FC6 and FC7 upon evaluation of the TE link information.

For example, path 1 of the network of FIG. 6 comprising the FC devices FC2, FC3, FC4, FC7, and FC8 has a bandwidth of 40 Mbps while path 2 comprising the FC devices FC2, FC3, FC5, FC6, FC7 and FC8 has a bandwidth of 100 Mbps. If a service that requires 40 Mbps bandwidth and a service that requires 70 Mbps bandwidth are present, traffic engineering will assign the 40 Mbps service to path 1 and the 70 Mbps service to path 2.

After a CRLSP tunnel has been set up, the head end node FC device FC2 will transmit RSVP PATH messages along the set path (the Constrained Shortest Path) to the tail end node FC device. In operation, the RSVP PATH messages will be sent to the downstream FC device FC3 first. FC3 will save the receive link information carried by the PATH message in its memory and to forward the link information to another downstream FC device which is FC5, and then to FC6 and FC7, until the PATH packet reaches the tail end node FC device FC 8.

Upon receipt of the PATH message, the tail end node FC device FC8 will initiate the label distribution process and send the RESV message back to the head end node FC device FC2. In this process, FC8 will assign a CRLSP label to the upstream FC device FC7 and send a RESV packet back to FC7. FC7 will save the information carried by the RESV packet in its memory and reserve adequate bandwidth resources. In addition, FC7 will also assign a CRLSP label to its upstream FC device FC6, and then feedback a RESV packet to FC6, and so on, until the RESV packet is fed back to the head-end tail node FC2.

Once the RESV packet is received by the head end node FC device, a tunnel is established. This tunnel is an LSP (Label Switched Path) tunnel of the specific type CRLSP, and FC2 will forward the data traffic across the LSP tunnel to the tail end FC device FC8.

So that the RSVP protocol messages can be carried by a PATH message to facilitate traffic engineering management in the FC network, FC SW_ILS type messages are used to carry RSVP protocol messages. For example, SW_ILS command codes having the encoded values between ‘A00000000’ and ‘A0000000A’ are added as new FC SW_{—ILS} type command messages to carry the example RSVP messages defined below:

| Encoded Value (hex) | Description | Abbr. |
|---|---|---|
| 01000000 | Switch Fabric Internal Link Service | SW_RJT |
| | Reject | |
| . . . | . . . | . . . |
| 16000000 | Link State Acknowledgement | LSA |
| . . . | . . . | . . . |
| A00000000 | RSVP: Path Messages | PATH |
| A00000001 | RSVP PathTear Messages | PTEAR |
| A00000002 | RSVP: PathErr Messages | PERR |
| A00000003 | RSVP: Resv Messages | RESV |
| A00000004 | RSVP: ResvTear Messages | RTREAR |
| A00000005 | RSVP: ResvErr Messages | RERR |
| A00000006 | RSVP: ResvConf Messages | RCONF |
| A00000007 | RSVP: HELLO Messages | RHLO |
| A00000008 | RSVP: Bundle Messages | BUND |
| A00000009 | RSVP: Ack Messages | ACK |
| A0000000A | RSVP: Srefresh Messages | SREF |

When establishing the CRLSP tunnel, tunnel characterizing objects carried by the PATH message will include the following example TLV fields:

Session Object; RSVP_HOP Object; RSVP_Label_Request Object; Explicit Route Object; Sender_Template Object; and Record Route Object.

In particular, the Session Object contains a value indicating the addresses of the tail end node device at the end of the tunnel, which is the address ‘10.1.8’ in the example of FIG. 6, and the address of the first FC device at the beginning of the tunnel which is ‘10.1.2’ in the example of FIG. 6. The identification number of the tunnel at the first FC device is to be assigned. In practice, several tunnel identification numbers may be required to distinguish different tunnels which may be set up by the head end FC node.

The RSVP_HOP Object contains a value indicating the address of the previous hop FC device, that is, the upstream FC device and the interface or port index of that upstream FC device from which the PATH message was sent. For example, where a PATH message was sent by interface port ‘1’ of FC2 to interface port ‘2’ of FC3, the value of the RSVP_HOP Object will contain the address ‘10.1.2’ and the interface port identity ‘1’ of FC2. Upon receipt of the PATH message by FC3, FC3 will record that FC2 is the upstream FC device and the PATH message was sent from interface port ‘1’ of FC2.

The RSVP_LABEL_REQUEST object indicates that a label binding for this path is requested and provides an indication of the network layer protocol that is to be carried over this path. The value may be used to indicate the FC network.

The Explicit Route Object will include a value indicating the addresses of each FC device and the associated interface port number involved in the path.

The SENDER_TEMPLATE Object contains the following values: the address of the head end node FC device at the beginning of the tunnel and the LSP ID. The address of the head end node FC device is ‘10.1.2’ and the LSP ID will be the actual number ‘100’ of the CRLSP.

The Record Route Object will include the values of the FC devices and the interface ports through which the PATH message has passed prior.

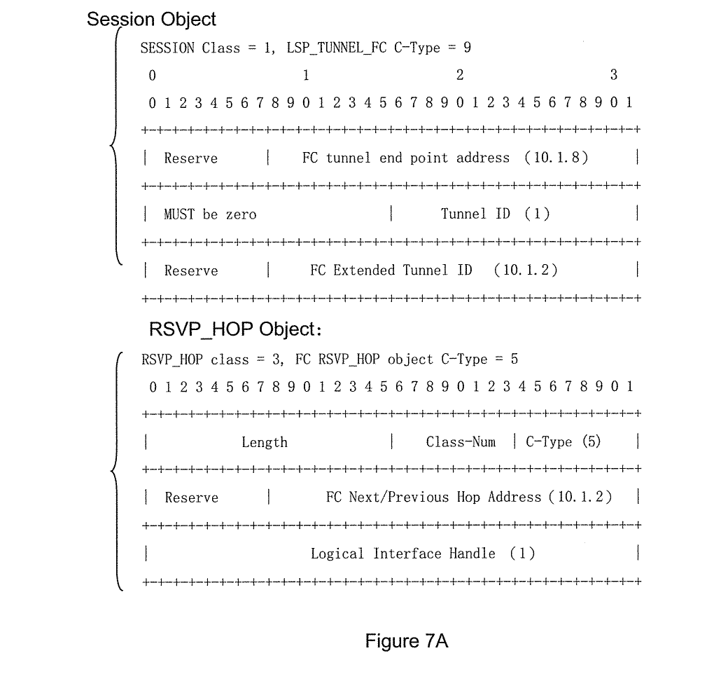

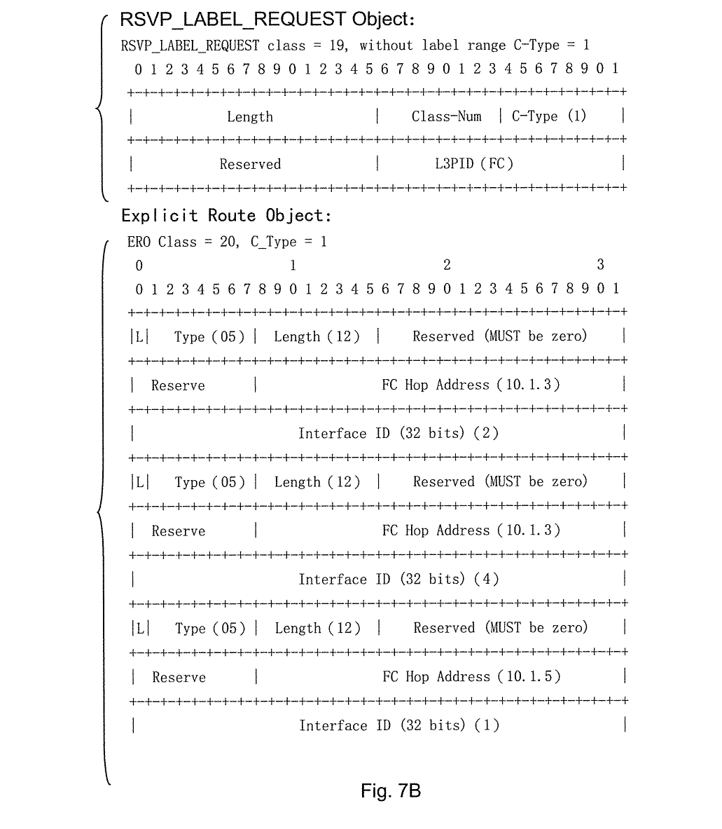

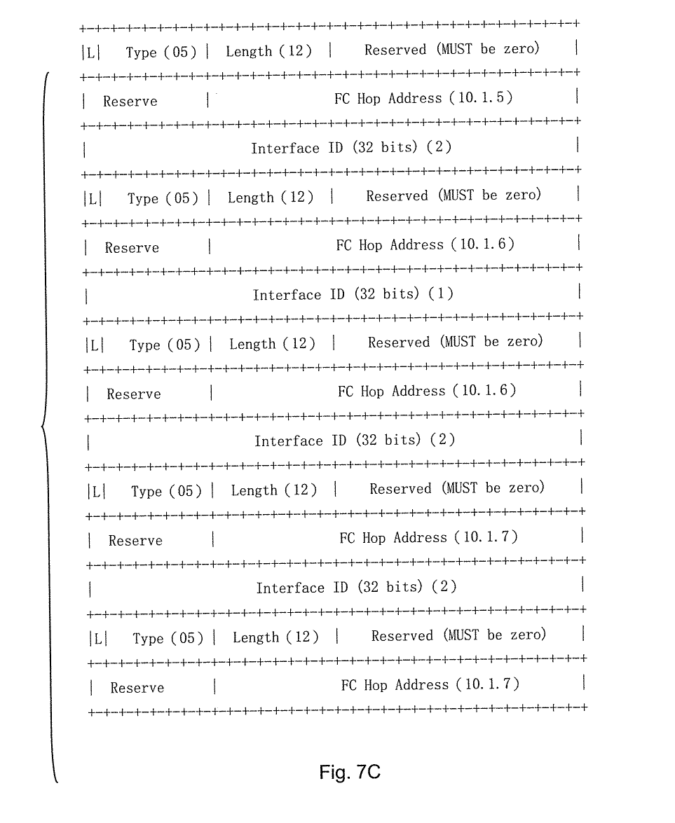

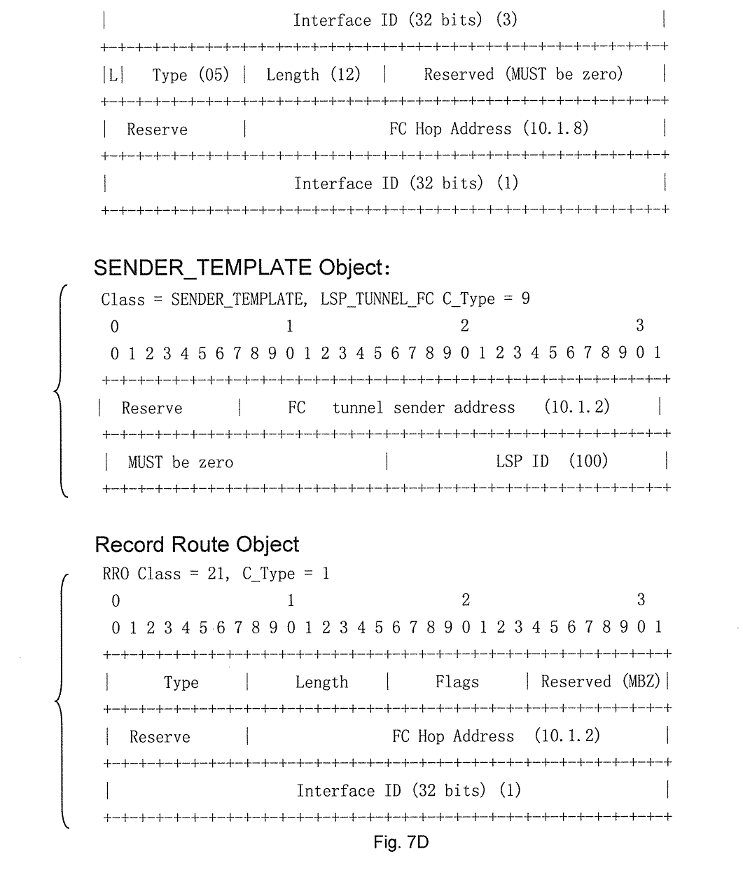

FIGS. 7A to 7C show example PATH messages sent by FC2 to FC3 to implement traffic engineering in the FC network. The PATH messages include ‘Session Object’, ‘RSV_HOP Object’, RSVP_Label_Request Object, Explicit Route Object, etc.

Upon receipt of the PATH message from FC2, FC3 will forward the PATH message to the downstream FC device which is FC5. The address of the FC device to be forwarded will included in the field ‘Explicit Route Object’. It will be seen from the Explicit Route Object field of FIG. 5B that the PATH message will be forwarded from port ‘4’ of FC3 (10.1.3) to port ‘1’ of FC5 (10.1.5).

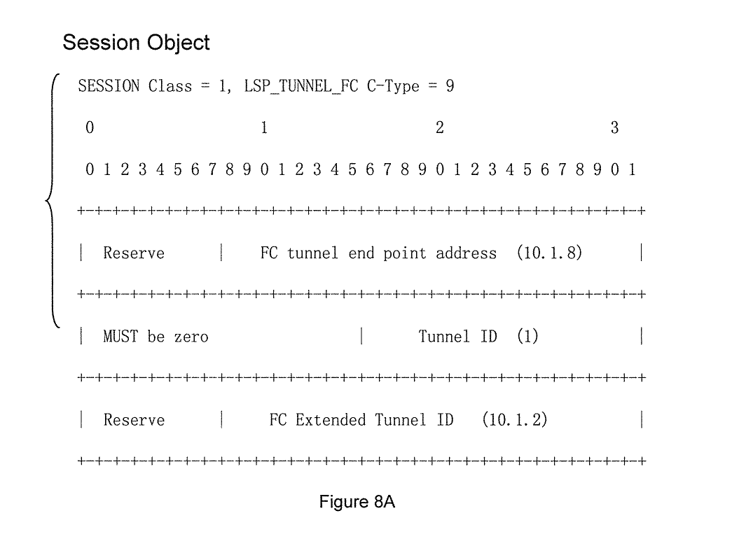

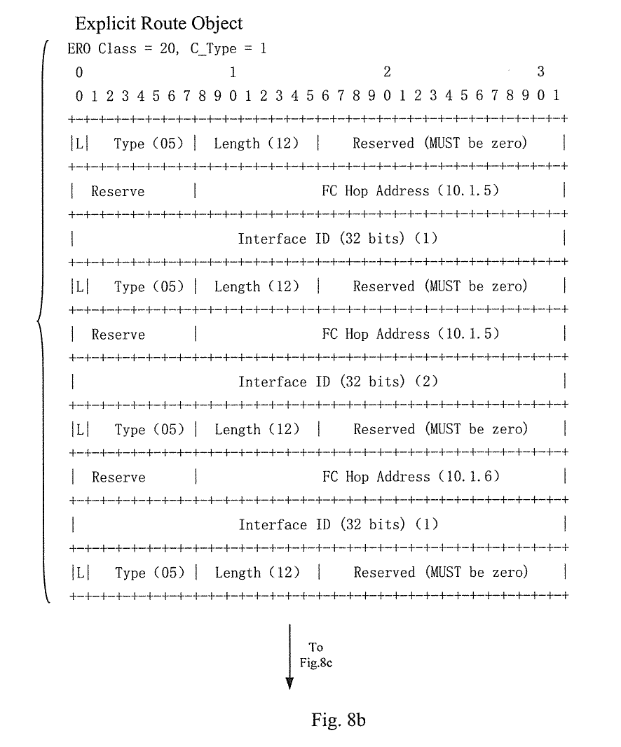

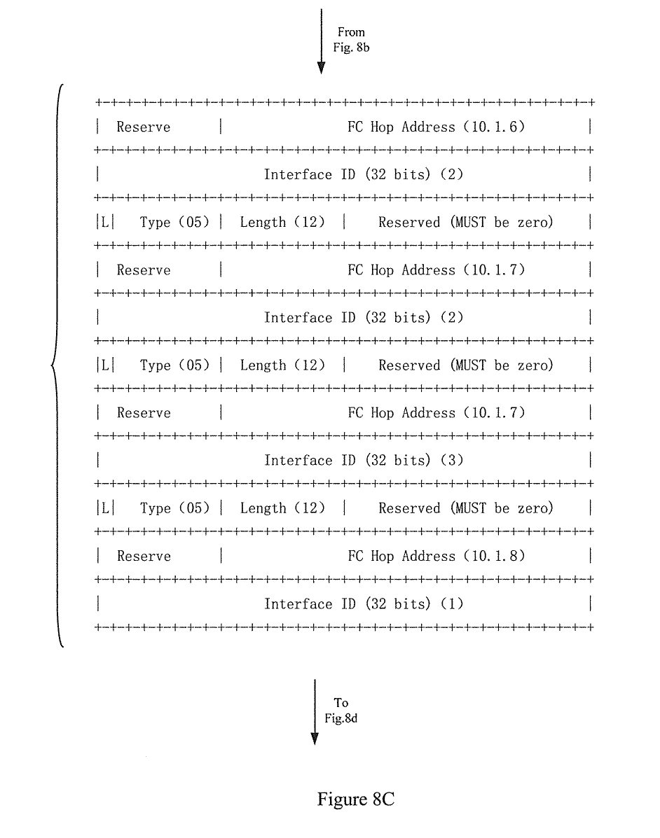

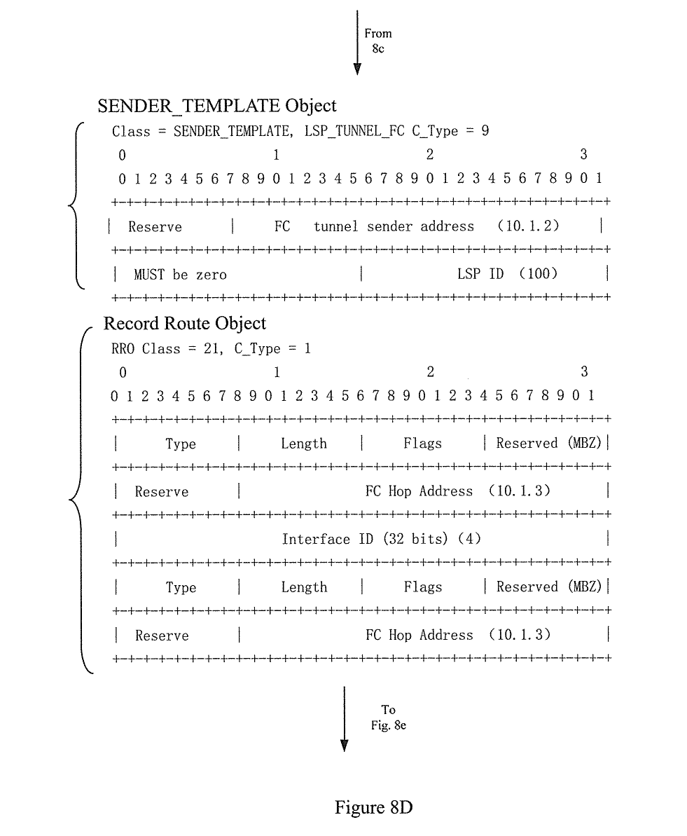

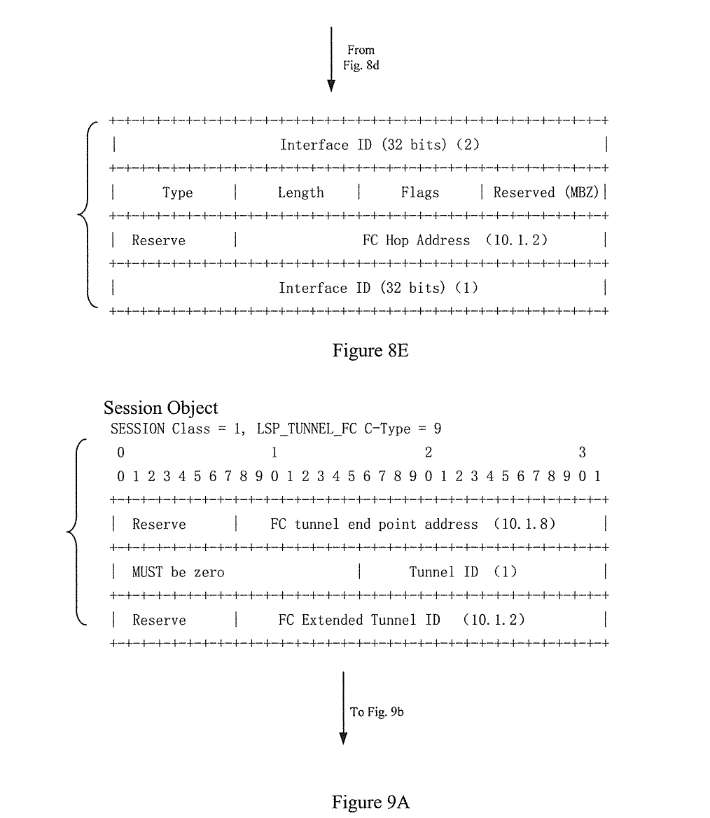

When forwarding the PATH message, some message contents will be modified. For example, when the PATH message was received by FC3, the last hop information ‘RSCP_HOP Object’ will contain the address of FC2 and port interface index number ‘1’. When FC3 is to forward the PATH message, the last hop information ‘RSCP_HOP Object’ will need to be updated to contain the address of FC3 and the port interface index number ‘4’. In addition, when the PATH message is received by FC3, the address and port interface number of FC3 will be deleted from the field Explicit Route Object. Moreover, the address and port interface number of FC3 will need to be added to Record Route Object. Forwarding of the PATH message by FC3 to FC5 will follow a manner similar to that described above and example messages are depicted in FIGS. 8A to 8E.

The RESV messages include TLV type fields such as the tunnel Session Object, RSVP_HOP Object, Filter_Specification Object, Label Object, and Record Route Object. For example, contents of the RESV Session Object are identical to that of the PATH message. The RESV RSVP_HOP Object of the tunnel is similar to that of the RSVP_HOP Object of the PATH message except that the value is the address of the downstream FC device which sends the RESV message. For example, when the RESV message was sent by interface port 1 of FC6 to FC5, and the PATH message was sent by interface port 2 of FC5 to FC6, the value of the RESV RSVP_HOP Object should contain the address ‘10.1.5’ of FC6 and interface port number 2 of FC5.

The Filter_Specification Object contains value of the address of the head end FC node device at the beginning of the tunnel and the LSP ID. The LSP ID field contains the actual identification ‘100’ of the CRLSP tunnel.

The LABEL Object field contains the value of a label distributed by the FC device upstream of the FC device which sent the RESV message.

The Record Route Object field contains the value of the addresses of the FC devices and the associated interface port numbers through which the RESV message had passed.

The RESV message transmission is in substance a reversal of the PATH message transmission process.

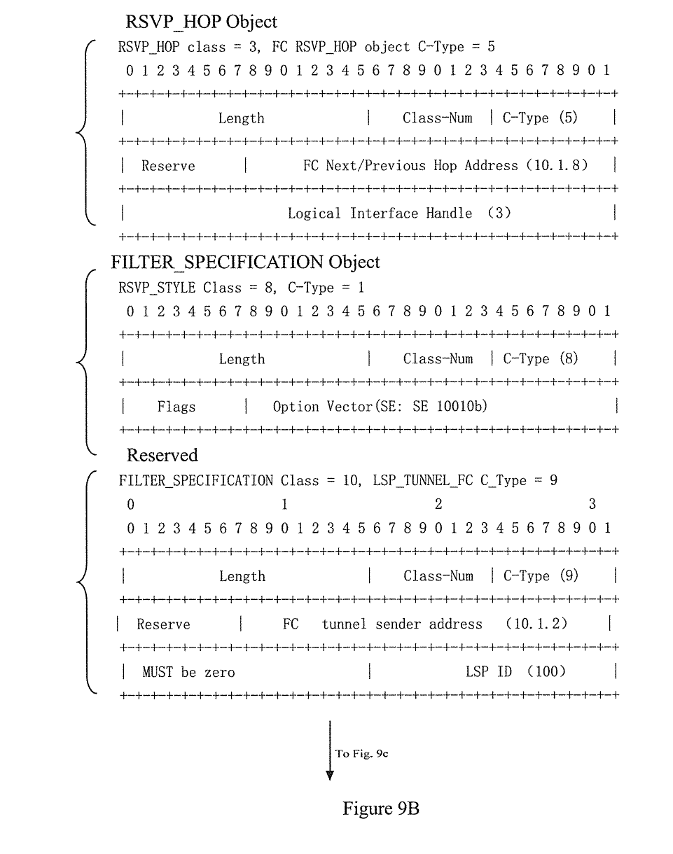

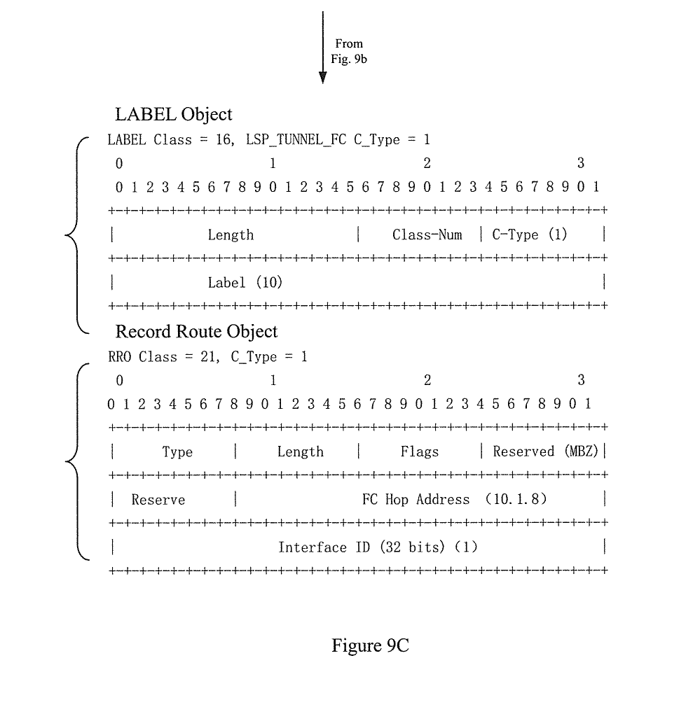

FIGS. 9A to 9C depict example RESV feedback messages to be sent by FC8 to FC7. After receipt of the RESV message by FC7, the RESV message will be sent by FC7 to the upstream FC6 through interface port number ‘2’ of FC7 to provide further feedback of the RESV message.

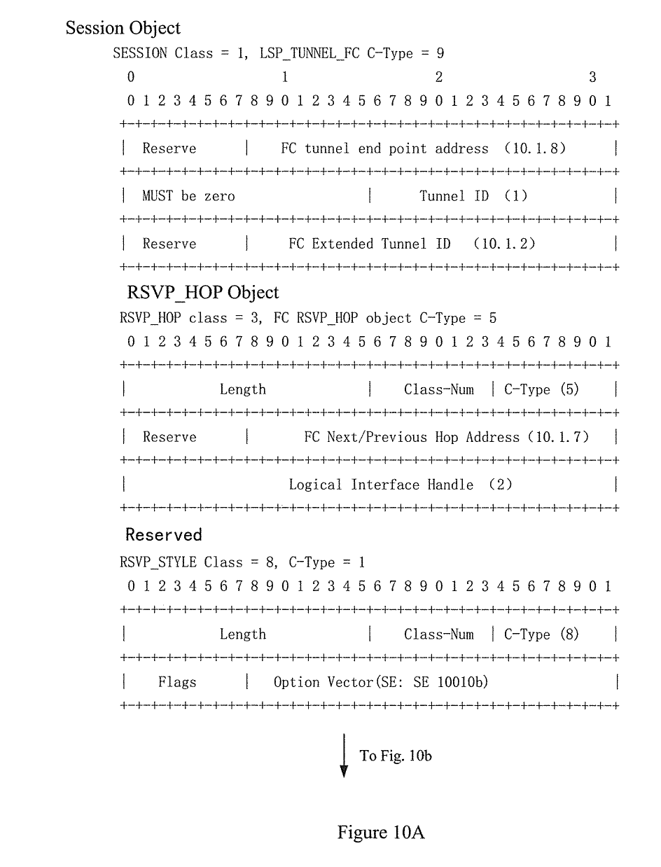

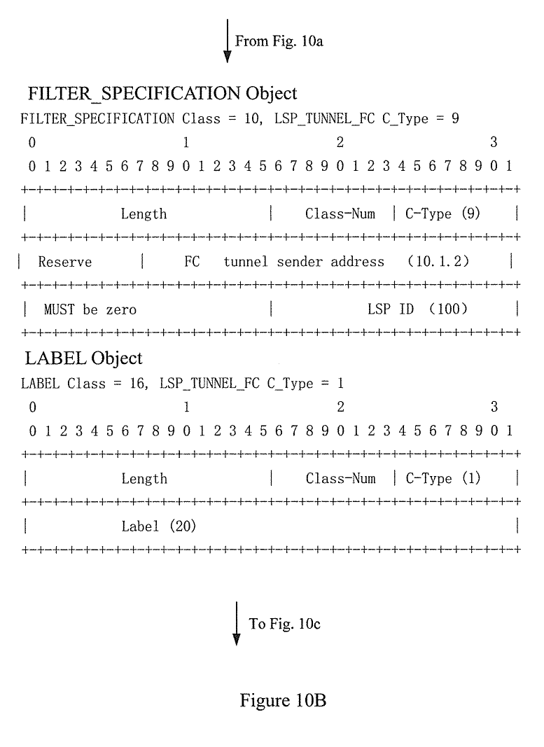

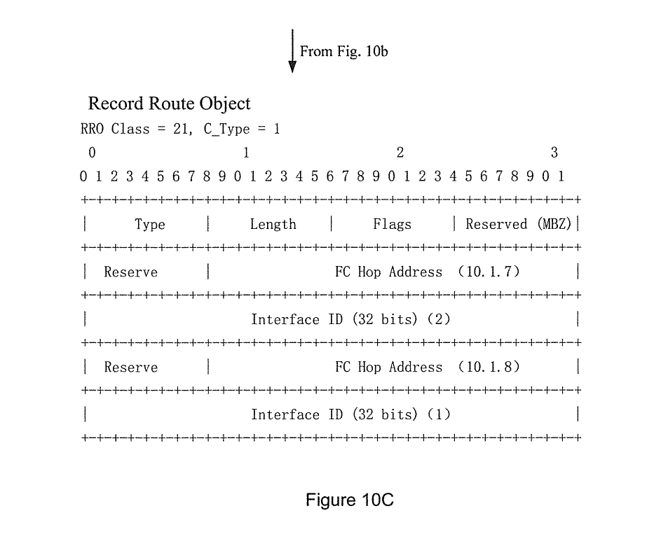

When FC7 intends to send the RESV message to FC6, the RESV message which FC7 received from FC8 will require modification or updating before sending. For example, the address of FC8 and the interface port number ‘3’ of FC3 included in the incoming RSVP_HOP Object message to FC7 will need to be updated to include the address of FC7 and the index number ‘2’ of FC6. As an additional example, the value of the Label Object allocated to FC8, which is 10, was included in the incoming RESV message received by FC7 from FC6. When FC7 intends to send the RESV message to FC6, the value of the LABEL object is required to be updated to 20, which is the LABEL Object value of FC6. Furthermore, when FC7 intends to send the RESV message to FC6, the address value ‘10.1.7’ and interface port number ‘2’ of FC7 is required to be included in the Record Route Object. Likewise, the RESV message to be sent from FC7 to FC6 is depicted sequentially in FIGS. 10A to 10C.

When a feedback RESV message is received by a FC device from a downstream FC device, the CRLSP label of the downstream FC device can be extracted from that RESV message, and this label will become the in-label of this node. When the FC device has reserved the available bandwidth resources, the CRLSP associated with that node will be formed. For example, FC8 has allocated a CRLSP having a label ‘10’ for FC7, and FC7 has allocated a CRLSP having a label ‘20’ for FC6, and a CRLSP having the following characteristics will be formed at the node of FC7.

| In label | Out port | Out label |
|---|---|---|
| 20 | 3 | 10 |

### CRLSP at FC7

Other CRLSPs associated with the FC device nodes of the FC network will be established in the same or similar manner. When all component CRLSPs have been established at all the FC device nodes, a complete CRLSP tunnel is established and ready for data traffic from the head end node FC device. When data traffic is transmitted from FC2 to FC8 in the FC network of FIG. 6, the messages will carry with it the CRLSP labels without loss of generality.

1. A fiber channel device comprising a processor to distribute and receive link constraint information on available links when there is a need to transmit data packets to a destination, and to establish a constraint-based routed label switch path (CRLSP) to transmit data packets to the destination.

2. A fiber channel device according to claim 1, wherein the link constraint information includes bandwidth information of a link, such as bandwidth available, and/or maximum bandwidth, and/or traffic characteristics such as TE metrics and/or affinity attribute.

3. A fiber channel device according to claim 1, wherein the processor is to distribute the link constraint information by Integrated Gateway Protocol (IGP) protocol.

4. A fiber channel device according to claim 1, wherein the processor is to distribute the link constraint information by means of Fiber Shortest Path First (FSPF) protocol, and the link constraint information is contained in the Link State Record (LSR) command as an extension.

5. A fiber channel device according to claim 4, wherein the link constraint information is contained in TLV (type, value and length) messages.

6. A fiber channel device according to claim 1, wherein the processor is to compute the CRLSP based on Constraint based Shortest Path First (CSPF) algorithm, and the constraints include available bandwidth, and/or affinity attribute, and/or TE (traffic engineering) metric, and whether Strict or Loose Explicit Route is supported.

7. A fiber channel device according to claim 1, wherein the processor is to send a RSVP-PATH message to establish the CRLSP.

8. A fiber channel device according to claim 7, wherein the processor is to send a RSVP-RESV message to reserve bandwidth of a link to form the CRLSP.

9. A fiber channel device according to claim 1, wherein the device is to construct a database on link constraint information upon receipt of link constraint information on all available links, and the device comprises a memory to store the database.

10. A fiber channel device according to claim 1, wherein the device is configured as a Label Switched Router (LSR).

11. A fiber channel network comprising a plurality of FC devices according to claim 1 in network interconnection.

12. A method of data transmission in a fiber channel network, wherein data are transmitted from a head-end FC device to a tail-end FC device through a CRLSP, wherein FC devices intermediate the head-end FC device and the tail-end FC device are configured as Label Switched Routers (LSR).

13. A method according to claim 12, wherein the method comprises the head-end FC device flooding its link constraint information to all FC devices connected to the network using FSPF protocol and collecting link constraint information of all FC devices connected to the network to determine the CRLSP based on Constraint based routing.

14. A method according to claim 13, wherein the method comprises the head-end FC device flooding the link constraint information to all FC devices connected to the network by having the link constraint information contained in Link State Records (LSR).

15. A method according to claim 13, wherein the method comprises the head-end FC device setting up the CRLSP.

16. A method according to claim 12, wherein the link constraint information is contained in TLV (type, value and length) messages.
